(19) United States
(12) Patent Application Publication
(10) Pub. No.: US 2008/0168676 A1
(43) Pub. Date: Jul. 17, 2008

(54) Axially-compact dryer, particularly adapted for use with a tunnel washer

(75) Inventors: Justin E. Morrison, Churchville, NY (US); Kevin P. Roesser, Rochester, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Getinge Sourcing LLC

(21) Appl. No.: 11/654,134

(22) Filed: Jan. 17, 2007

(51) Int. Cl. F26B 25/06; F26B 19/00; F26B 3/00; F26B 21/00

(52) U.S. Cl. 34/201; 34/236; 34/524; 34/90; 34/282

(57) ABSTRACT

The present invention provides an improved dryer (22) that is adapted to dry an object (ο) and to an improved method of drying an object. The improved dryer (22) broadly includes: a conveyor (32) for translating an object (ο) to be dried, the conveyor having an entrance end (33) and an exit end (34); an enclosure (35) surrounding the conveyor; a movable panel (36) arranged within the enclosure; an actuator (38) mounted on the enclosure and operatively arranged to selectively move the panel toward and away from the object; a first air knife (39) operatively arranged to discharge a first jet of air through the conveyor toward the object; and a second air knife (40) mounted on the movable panel and operatively arranged to discharge a second jet of air toward the object; whereby the actuator may be operated to move the panel into closer proximity with the object as the object moves along the conveyor from the entrance end to the exit end to dry the object.

### TECHNICAL FIELD

The present invention relates generally to tunnel washers for washing various utensils and vivarium objects, and, more particularly, to an improved axially-compact dryer that is particularly adapted for (but not necessarily limited to) use with such a tunnel washer.

### BACKGROUND ART

In vivarium operations, laboratory animals are often stored in various transparent cages. These cages have bottoms and lids that must be cleaned from time-to-time.

Tunnel washers have been developed for washing a wide variety of goods. For example, in hospitals, various reusable products are mounted on wheeled carts, and are advanced through a tunnel washer. A tunnel washer is, from a functional point-of-view, simply an elongated tunnel-like space having an entrance end and an exit end. Goods to be washed are admitted to the washer at the entrance end, are translated axially along the length of the washer, and are discharged from the exit end.

Examples of various tunnel washers are shown in a brochure on the SL1200-tunnel washer produced by Schlyer Machine, 814 Wurlitzer Drive, North Tonawanda, N.Y. 14120. Another a tunnel washer-dryer is produced by Scientek, 11151 Bridgeport Road, Richmond, B.C., Canada V6X 1T3.

Other conveyorized tunnel-washers are made by Douglas Machines Corp.

Another device is referred to as the Model 600 extended conveyor cleaning system made by Guyson Corporation, W.J. Grande Industrial Park, Saratoga Springs, N.Y. 12866.

Still another tunnel cage and utensil washer is the Getinge Series 3200 unit. This product is available from Getinge USA, Inc., 1777 East Henrietta Road, Rochester, N.Y. 14623. The present invention is particularly adapted for (but not necessarily limited to) use with such a Getinge Series 3200 tunnel washer.

Accordingly, while tunnel washers with integral dryers are known, it would be generally desirable to provide an improved dryer for use in association with such a tunnel washer, which dryer is more compact in the axial direction than dryers heretofore available.

### DISCLOSURE OF THE INVENTION

With parenthetical reference to the corresponding parts, portions or surfaces of the disclosed embodiment, merely for purposes of illustration and not by way of limitation, the present invention broadly provides an improved dryer that is adapted to dry an object and to an improved method of drying an object.

According to one aspect, the improved dryer (22) broadly includes: a conveyor (32) for translating an object (ο) to be dried, the conveyor having an entrance end (33) and an exit end (34); an enclosure (35) surrounding the conveyor; a movable panel (36) arranged within the enclosure; an actuator (38) mounted on the enclosure and operatively arranged to selectively move the panel toward and away from the object; a first air knife (39) operatively arranged to discharge a first jet of air upwardly through the conveyor toward the object; and a second air knife (40) mounted on the movable panel and operatively arranged to discharge a second jet of air toward the object; whereby the actuator may be selectively operated to move the panel into closer proximity with the object as the object moves along the conveyor from the entrance end to the exit end to dry the object.

The improved dryer may further include a sensor (41) arranged to sense the height of the object on the conveyor and to produce an output signal reflective of such sensed height. The sensor output signal may be supplied to the actuator (38), and the movable panel (36) may be moved to a position of close proximity to the object as a function of the sensor output signal.

In the preferred embodiment, the improved dryer is associated with a tunnel washer (20) having an entrance end (23) and an exit end (24), and the sensor is located at the entrance end of the tunnel washer.

The conveyor may include a plurality of rollers positioned between the entrance end and the exit end, or may have some other form.

The first air knife may be positioned between two adjacent rollers. Indeed, there may be a plurality of first air knives positioned at various axially-spaced locations along the conveyor.

The movable panel may possibly be located overhead, and may be selectively movable upwardly and downwardly. Alternatively, the movable panel may be movable laterally (i.e., horizontally) toward and away from the object.

In another aspect, the invention provides an improved method of drying an object (ο), which includes the steps of: providing a conveyor (32) for translating an object to be dried, the conveyor having an entrance end (33) and an exit end (34); providing an enclosure (35) about the conveyor; providing a movable panel (36) within the enclosure; mounting a first air knife (39) to selectively discharge a first jet of air upwardly through the conveyor toward the object; mounting a second air knife (40) on the panel to discharge a second jet of air toward the object; translating an object (ο) along the conveyor from the entrance end to the exit end; moving the panel into closer proximity to the object as it translates along the conveyor; discharging a first jet of air through the first air knife upwardly toward the object; discharging a second jet of air through the second air knife downwardly (or laterally) toward the object; thereby to dry the object as it translates along the conveyor from the first end to the second end.

This method may further include the additional steps of: sensing the height of the object to be dried; and moving the panel into closer proximity to the object as a function of the sensed height.

Accordingly, the general object of this invention is to provide an improved dryer, and method for drying an object.

Another object is to provide an improved axially-compact, but yet highly-efficient, dryer for use with a tunnel washer.

These and other objects and advantages will become apparent from the foregoing and ongoing written specification, the drawings and the appended claims.

### BRIEF DESCRIPTION OF THE DRAWINGS

FIG. 1 is an isometric view of a Getinge 3200 tunnel washer having a leftward entrance end and a rightward exit end, this structure embodying the improved dryer proximate its outlet end.

FIG. 2 is an isometric view of the dryer portion of the structure shown in FIG. 1, with the enclosing outer walls removed, this view showing the conveyor, a plurality of axially-spaced first air knives arranged to discharge air upwardly between various conveyor rollers, the overhead movable panel, and the actuator for selectively moving the same in a vertical direction.

FIG. 3 is a schematic view generally similar to FIG. 2, with the actuator removed, and showing the movable panel as being in a retracted position overhead two inverted box-like objects that are translating along the conveyor.

FIG. 4 is a view generally similar to FIG. 3, again with the actuator removed, but showing the movable panel as having been moved downwardly toward the objects to dry the objects.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

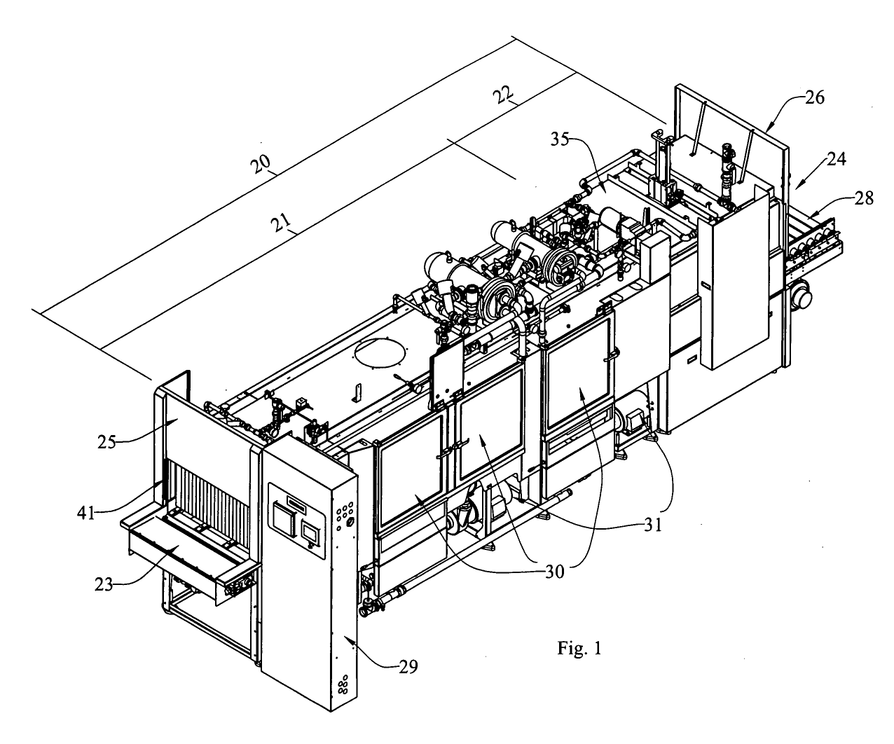

Referring now to the drawings, and, more particularly, to FIG. 1 thereof, an improved tunnel washer is generally indicated at 20. Tunnel washer 20 is shown as having a washer portion 21 and a dryer portion 22. The entire tunnel washer extends between a leftward or entrance end 23, and a rightward or exit end 24. Operation of the washer is shown as being controlled by means of a panel controller 29.

The entire tunnel washer 20 subjects the articles-to-be-washed to five treatment phases or cycles, and these are typically encountered sequentially as the items move from the entrance end of the washer 23 to the exit end 24. These five phases include: (1) pre-wash, (2) agent wash, (3) recirculated rinse, (4) non-recirculated final rinse, and (5) drying. The first four steps are performed in the washer portion 21, and the last step is performed in the dryer 22.

The washer portion 21 is individually old, but provides an environment for use of the improved dryer.

In the pre-wash phase, hot water from a rinse tank (not shown) is directed through lowered jet spray headers (not shown) under pump pressure to remove gross soil. Cold water is added to the upper header (not shown) to condense steam and cool drain water. The water solution is not recirculated, and is directed to drain.

In the agent wash phase, hot detergent solution from a wash tank (not shown) is recirculated through the wash jet spray header (not shown) under pump pressure and is retained in the wash tank. The wash temperature is selectively programmable up to about 190° F.

In the recirculated rinse phase, hot water from the rinse tank is recirculated through rinse spray headers (not shown), and powers the pre-wash lower header under pump pressure and retained in the rinse tank. The rinse temperature is also programmable to about 190° F.

In the non-recirculated final rinse, hot tap water from house supply is heated by a steam heat exchanger (not shown), and is directed through separate final rinse jet spray headers (not shown) under house supply pressure and retained in the rinse tank for the recirculated rinse and pre-wash. Final rinse temperature can be manually programmed to about 195° F.

In the air dryer, hot air is drawn through a finned steam coil (not shown), and is directed to be discharge through air knives. The dryer temperature is PLC-programmable. Moisture is eliminated by exhausting a portion of the chamber air to the facility exhaust system.

Adverting to FIG. 1, the tunnel washer 20 is shown as having a plurality of side access doors, severally indicated at 30, a series of pumps, severally indicated at 31. As previously noted, the washer portion 21 of tunnel washer 20 is individually old.

The present invention provides an improved dryer, generally indicated at 22.

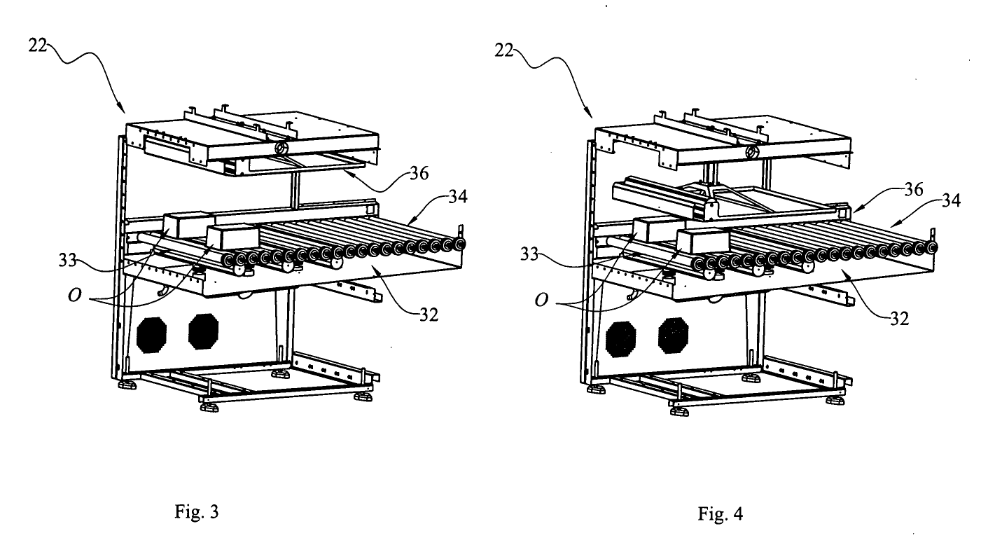

Referring now to FIGS. 1-4, the improved dryer 22 is arranged to dry an object, such as the inverted box-like clear plastic animal cages, severally indicated at ο in FIGS. 3 and 4.

The improved dryer is depicted as having a conveyor, generally indicated at 32, for translating and conveying an object to be dried between an entrance end 33 and an exit end 34. In the disclosed embodiment, the conveyor includes a plurality of axially-spaced freely rotatable rollers. However, this is not invariable, and may be changed. The dryer also includes a four-sided enclosure, generally indicated at 35, surrounding the conveyor.

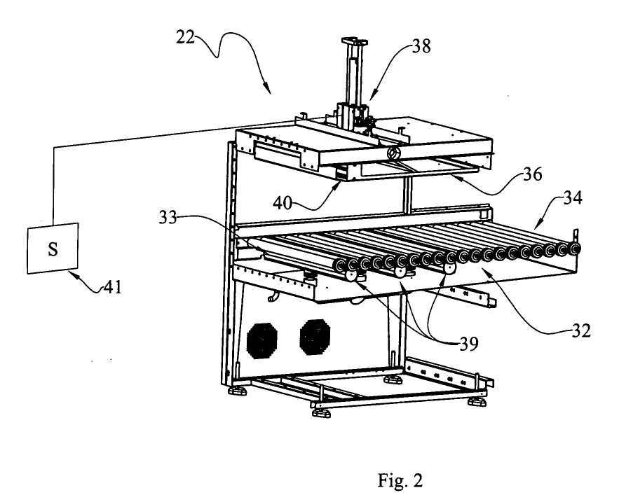

As best shown in FIGS. 2-4, a movable panel, generally indicated at 36, is operatively arranged within the enclosurer. An actuator, generally indicated at 38, is mounted on the enclosurer and is operatively arranged to selectively move the panel toward and away from the object. In the preferred embodiment, the movable panel is positioned overhead the objects, and the actuator is operatively arranged to selectively move the panel upwardly and downwardly relative to the objects-to-be-dried. However, this is not invariable. In an alternative arrangement (not shown), the movable panel might be movable laterally (i.e., horizontally) toward and away from the objects. Moreover, there need not be only one movable panel. Multiple panels might possibly be provided.

The invention is shown as further including at least one first air knife, indicated at 39, that is operatively arranged to discharge a first jet of air through the conveyor toward the object. These air knives are commercially available from Sonic Air Systems, 150 Beacon Street, Brea, Calif. 92821. In FIG. 2, there are three such first air knives, severally indicated at 39. These three knives are positioned at various axially-spaced locations along the conveyor, and are arranged to discharge their respective distributed air jets upwardly between adjacent rollers of the conveyor. The discharged air may be heated or not.

The invention is shown as further including a second air knife 40 that is operatively mounted on the movable panel and is operatively arranged to discharge a second jet of air downwardly toward the object. This air knife may be structurally similar to air knives 39, 39, 39. Each of these various air knives has a somewhat teardrop-shaped transverse cross-section which includes a rounded, enlarged plenum chamber and a smaller throat-like neck portion through which air will be discharged.

In the preferred embodiment, a sensor 41 is operatively arranged to sense the vertical height of the object passing through the tunnel washer and to produce an output signal reflective of sensed height. This output sensor is supplied to the actuator, and is used to selectively move the panel between a raised out-of-the-way position (FIG. 3), and a lowered position in close proximity to the object (FIG. 4). The sensor is arranged to sense and determine the height of the object to be dried, and to cause the movable panel to move downwardly to a position in close proximity to that particular object, when it reaches the dryer. The sensor may be located at the entrance end of the tunnel washer, or may be located at the entrance end of the dryer, or may be located at still some other location.

FIG. 3, is schematic isometric view depicting the movable panel as being in a raised position elevated substantially above the two objects-to-be-dried.

FIG. 4 depicts the actuator as having moved the movable panel downwardly into closer proximity with the objects. This is also beneficial in the event that the upwardly-discharging air through the first air knives may tend to move the objects upwardly. The lowered panel serves as a restraint against unlimited upward movement of the objects. After the objects have exited the conveyor, the movable panel may be returned to its elevated position.

Accordingly, the present invention provides an improved dryer which is adapted to dry an object. The improved dryer broadly includes a conveyor 32 for translating an object (ο) to be dried. The conveyor has an entrance end 33 and an exit end 34. A four-sided enclosurer 35 surrounds the conveyor in the dryer. A movable panel 36 is mounted within the enclosurer. An actuator 38 is mounted on the enclosurer and is operatively arranged to selectively move the panel toward and away from the object. A first air knife 39 is operatively arranged to discharge a first jet of air upwardly through the conveyor toward the object. A second air knife 40 is mounted on the movable panel is arranged to discharge a second jet of air downwardly toward the object. In practice, there may be three axially-spaced first air jets, and one second air jet, or some other numbers of such air knives, as desired. The actuator is operated to move the panel into closer proximity with the object as the object moves along the conveyor from the entrance end to the exit end, and to dry the object by the discharge of air through the first and second air jets.

In the disclosed embodiment, the object is depicted as being an inverted plastic box-like structure. There is a need for only one second air jet, because the discharge jet of the second jet of air tends to cause the water to bead and run off the surfaces of the object.

However, three first air jets are provided to allow for adequate drying of the interior of the inverted box-like structure, inasmuch as there is no real opportunity for water to run off the object.

In another aspect, the invention provides an improved method of drying an object, which method includes the steps of: providing a conveyor for translating an object to be dried; the conveyor having an entrance end and exit end; providing an enclosurer about the conveyor; providing a movable panel within the enclosurer; mounting at least one first knife so as to selectively discharge a first set of air upwardly through the conveyor toward the object; mounting at least one second air knife on the panel to discharge a second jet of air toward the object; translating the object along the conveyor from the entrance end to the exit end; moving the panel into closer proximity to the object before it translates along the conveyor; discharging a first jet of air through each first air knife toward the object; discharging a second jet of air through each second air knife toward the object; thereby to dry the object as it translates along the conveyor from the first end to the second end. The improved method may further include the step of sensing the height of the object to be dried; and moving the panel into closer proximity to the object as a function of such sensed height.

### Modifications

The present invention expressly contemplates that many changes and modifications may be made.

For example, and as previously noted, in the preferred embodiment, the panel is mounted overhead within the enclosure for vertical movement upwardly and downwardly relative to the object. However, in another embodiment, the associated movable panel might be movable laterally within the enclosurer toward and away from the object. Indeed, there could be multiple panels capable of approaching the object from opposite directions. There may be one or more first air jets. These may be of the type made by Sonic Air Systems, or of some other design. The air discharged therethrough may be either heated, cooled or at room temperature, as desired.

The sensor, which is used to determine the height of the object, may be positioned at the entrance end of the tunnel washer, or at some intermediate location, or at the immediate entrance end of the dryer portion, all as desired. It is presently preferred that the panel move to a position of close proximity just as the objects enter the dryer portion. After the objects have translated through the dryer, the panel may be returned to its initial out-of-the-way position.

Conveyors other than those having axially-spaced freely-rotatable or powered rollers may be used.

Therefore, the present invention provides an improved dryer, and method of operating a dryer. The invention is deemed to have particularly utility in association with a tunnel washer, of the various types disclosed herein. However, the improved dryer might be associated with some other type of device as well.

Therefore, while the presently preferred form of the improved dryer has been shown and described, and several modifications thereof discussed, persons skilled in this art will readily appreciate that various additional changes and modifications may be made without departing from the spirit of the invention, as defined and differentiated by the following claims.

What is claimed is:

1. A dryer adapted to dry an object, comprising:
a conveyor for translating an object to be dried, said conveyor having an entrance end and an exit end;
an enclosure surrounding said conveyor;
a movable panel arranged within said enclosure;
an actuator mounted on said enclosure and operatively arranged to selectively move said panel toward and away from said object;
a first air knife operatively arranged to discharge a first jet of air through said conveyor toward said object; and
a second air knife mounted on said movable panel and operatively arranged to discharge a second jet of air toward said object;
whereby said actuator may be operated to move said panel into closer proximity with said object as said object moves along said conveyor from said entrance end to said exit end to dry said object.

2. A dryer as set forth in claim 1, and further comprising:
a sensor arranged to sense the height of said object on said conveyor and to produce an output signal reflective of such sensed height.

3. A dryer as set forth in claim 2 wherein said sensor output signal is supplied to said actuator, and wherein said movable panel is moved to a position of close proximity to said object as a function of said sensor output signal.

4. A dryer as set forth in claim 3 wherein said dryer is associated with a tunnel washer having an entrance end and an exit end.

5. A dryer as set forth in claim 4 wherein said sensor is located at the entrance end of said tunnel washer.

6. A dryer as set forth in claim 1 wherein said conveyor comprises a plurality of rollers positioned between said entrance end and said exit end.

7. A dryer as set forth in claim 6 wherein said first air knife is positioned between two adjacent rollers.

8. A dryer as set forth in claim 7 wherein there are a plurality of first air knives positioned at spaced locations along said conveyor.

9. A dryer as set forth in claim 1 wherein said movable panel is located overhead, and is selectively movable upwardly and downwardly.

10. The method of drying an object, comprising the steps of:
providing a conveyor for translating an object to be dried, said conveyor having an entrance end and an exit end;
providing an enclosure about said conveyor;
providing a movable panel within said enclosure;
mounting a first air knife to selectively discharge a first jet of air through said conveyor toward said object;
mounting a second air knife on said panel to discharge a second jet of air toward said object;
translating an object along said conveyor from said entrance end to said exit end;
moving said panel into closer proximity to said object as it translates along said conveyor;
discharging a first jet of air through said first air knife toward said object; and
discharging a second jet of air through said second air knife toward said object;
thereby to dry said object as it translates along said conveyor from said first end to said second end.

11. The method as set forth in claim 10, and further comprising the additional steps of:
sensing the height of said object to be dried; and
moving said panel into closer proximity to said object as a function of said sensed height.
